(19) United States
(12) Patent Application Publication
(10) Pub. No.: US 2010/0312391 A1
(43) Pub. Date: Dec. 9, 2010

(54) Calibration Of A Lead-Through Teaching Device For An Industrial Robot

(75) Inventors: Sangeun Choi, Simsbury, CT (US); Thomas A. Fuhlbrigge, Ellington, CT (US); William Eakins, Bloomfield, CT (US); Gregory Rossano, Enfield, CT (US)

Correspondence Address: ABB INC.;LEGAL DEPARTMENT-4U6, 29801 EUCLID AVENUE, WICKLIFFE, OH, 44092, US

(73) Assignee: ABB Research Ltd., Zurich (CH)

(21) Appl. No.: 12/479,185

(22) Filed: Jun. 5, 2009

(51) Int. Cl. G06F 19/00

(52) U.S. Cl. 700/254; 901/5; 901/9; 901/42; 901/46

(57) ABSTRACT

A lead-through teaching device for an industrial robot is calibrated by moving the device to each of a predetermined number of reference poses. A controller responds to a signal from the device induced by gravity at each of the reference poses to calibrate the device to a predetermined coordinate frame. If necessary, a removable weight can be mounted to the device. The robot can hold either the tool that is to perform work on a workpiece or the workpiece. In those applications where the tool has a removable component, the lead-through teaching device can replace the removable component during its calibration to the predetermined coordinate frame.

### FIELD OF THE INVENTION

This invention relates to lead through teaching of industrial robots and more particularly to the design and calibration of a portable lead through teaching device.

### DESCRIPTION OF THE PRIOR ART

Most industrial robots are programmed by a “teach by showing” method. To teach the robot a point, the robot programmer needs to move the robot's tool center point (TCP) to the desired location, and then record the corresponding joint values in the memory of the robot controller. The robot controller will read and use these recorded values for playback later.

Almost every industrial robot comes with a teach pendant allowing the programmer to jog the robot manipulator to a desired point. The two most common mechanisms for jogging are i) a joystick, and ii) a keypad or keyboard. The operator moves the joystick or presses keys on the keypad or keyboard in the specified direction for translating or orienting the tool center point or to drive the individual joints separately.

When jogging the robot, it is sometimes easier to move the robot in the tool (or hand) coordinate frame than in the world or robot base coordinate frame. For example, when teaching multiple points along an arc-welding line, the welding torch tip (the tool) needs to move perpendicular to the welding line, and jogging the robot in the tool coordinate frame is much easier and intuitive to the programmer. A tool coordinate frame is a frame usually defined at the point located on the tool where an actual task is performed (e.g. gripper jaw, welding torch tip or glue gun tip).

In many cases, maneuvering robots using the joystick or keypad on the pendant along the desired path is not easy or intuitive. The robot operator must be able to easily maneuver the robot during the teaching process. For that to happen, the operator frequently needs to change his/her body position around the robot in order to have a better angle to view the robot and its tool. Therefore, it is hard for him/her to get adjusted to each new pose or orientation of the joystick or keypad relative to the robot's tool or base coordinate system.

To solve this problem, the lead-through teaching methodology was developed and successfully used for more efficient and intuitive teaching of discrete point or continuous-path robot programs. In lead-through teaching, the programmer directly grasps the lead-through handle, which is usually mounted on a certain location on the robot tool, and manually leads the robot through a desired path or successive points to define the path and/or points used for the task.

The major advantage of lead-through programming over teach pendant programming is the ease of path programming. The lead-through method is very intuitive and can be performed by an operator who knows the process and has very little robot programming experience. For this reason, the lead-through teaching technique has been applied to industrial tasks such as spray painting, sealant application, glue dispensing and arc welding, where the operator is required to move the robot tool along a smooth and continuous path.

Industrial robot manufacturers have developed lead-through teaching devices. One example of these devices is the programmable painting robot known as the IRB 540 sold by ABB. This robot has a mechanism for counterbalancing the weight of the manipulator. This mechanism allows the operator to grasp the handle provided on the tool and lead the robot through the desired paint path which is recorded by the memory associated with the robot for later playback. Another example of these devices is the robot shown by Reis Robotics that uses a 6 D mouse to jog the robot. The 6 D mouse is Space Control's Industrial Steering Device (ISD).

Examples of lead-through teaching devices are shown in the European Patent Application published as EP 1,724,072(A1), the published Japanese patent property JP 08336785 and U.S. Pat. No. 6,385,508. In all of these patent properties, force transducers are used to provide the robot with the operator's hand motion command. This requires a force transducer module and an electronics board to process the signal from the transducer.

### SUMMARY OF THE INVENTION

An industrial robot. The robot has:

a lead-through teaching device mounted in relationship to the robot to allow the robot to be moved to teach the robot a path to be used for a tool to perform work on a workpiece; and

a controller responsive to a signal from the lead-through teaching device induced by gravity and occurring at each of a predetermined number of reference poses to which the lead-through teaching device is moved for calibrating the lead-through teaching device to a predetermined coordinate frame.

An industrial robot. The robot has:

a lead-through teaching device mounted in relationship to the robot to allow the robot to be moved to teach the robot a path to be used for a tool to perform work on a workpiece; and

a controller, the controller responsive to a signal from the lead-through teaching device induced by gravity and occurring at each of a first and a second reference pose to which the lead-through teaching device is moved for calibrating the lead-through teaching device to a predetermined coordinate frame.

A robotic system having:

an industrial robot that has an arm having a tool mounted thereon, the tool for performing a predetermined operation on a workpiece and the tool having a removable component; and

a lead-through teaching device for attachment to the tool in place of the removable component when it is desired to teach the robot a path to be followed by the robot when the robot uses the tool and the removable component to perform the predetermined operation on the workpiece, and the lead-through teaching device being removable from the tool after the path is taught to the robot.

### DESCRIPTION OF THE DRAWING

FIG. 1 shows a robot with a jogging mouse mounted on a tool attached to the robot with the mouse having mounted thereon an extra weight for calibration purposes.

FIGS. 2a to 2c show three examples of reference poses for the jogging mouse with the extra weight mounted thereon.

FIGS. 3a to 3d show the steps for attaching the jogging mouse in place of a gas nozzle to a contact tip so that lead through teaching can be used and for removing the mouse and reattaching the nozzle to the contact tip after the lead through teaching operation is completed.

FIGS. 4a to 4d show example locations where the jogging mouse can be attached to the tooling of the robot.

FIG. 5 shows a diagram of a robot system in which the lead through device can be used.

### DETAILED DESCRIPTION

As is described above, a mouse can be used in a lead-through device for teaching a robot a path to be followed by a tool held by the robot when the robot is to perform a particular industrial task such as spray painting, sealant application, glue dispensing and arc welding. As is described in more detail below, the lead through teaching device described herein allows for easy calibration between the mouse coordinate frame and the tool coordinate frame. Also as is described in more detail below, the lead through teaching device allows the use of a gas nozzle to mount an easily removable lead-through mouse on an arc-welding robot's tooling.

The robot herein is described and shown as holding the tool which is used to perform work on a workpiece. While the workpiece is not shown it may be held by a device such as for example a fixture or a robot. The device holding the workpiece can depending on the application either hold the workpiece in a fixed position or move the workpiece relative to the tool. For example, it is well known in arc welding to use a device that rotates the workpiece, that is the part, to be welded while the robot moves the arc welding tool along the part. It is well known for tasks such as, for example and without limitation, grinding, polishing, milling and deburring to have the robot hold the workpiece and the tool which will perform the task on the workpiece to be held in a fixed position by any one of the well known means described above. Thus the robot holds an object which may be a tool or a workpiece.

The object held by the robot either works on another object which will be the workpiece when the robot holds the tool or has work performed on it by another object which will be the tool when the robot holds the workpiece. When the robot is holding the tool, the lead-through mouse is calibrated in relation to the tool coordinate frame. When the robot is holding the workpiece, the lead-through mouse is calibrated in relation to the workpiece coordinate frame, which is also known as a work object coordinate frame.

There is described below in combination with the drawings a methodology for a robot holding a tool to perform work on a workpiece held by a device other than the robot. That same methodology can be easily applied to the robot holding the workpiece and the tool to perform work on the workpiece held by a device other than the robot. The device other than the robot that holds the object, that the workpiece or tool, can as described above either hold the object in a fixed position relative to the robot or move the object relative to the robot.

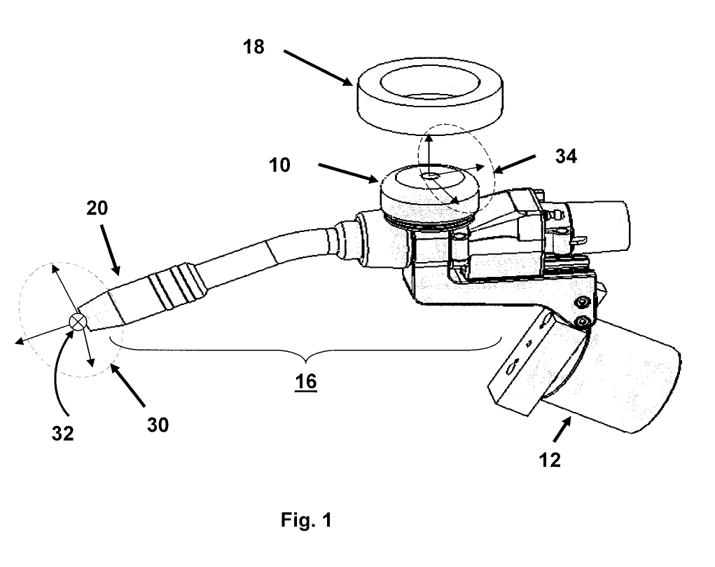

Referring now to FIG. 1, there is shown a tool 16 mounted on a robot which is shown in its entirety in FIG. 5 and identified therein as 52. For ease of illustration, only the end effector region of the robot 52 is shown in FIG. 1. In FIG. 1, the tool 16 is shown as a welding torch having a nozzle 20. An adaptor 12 is used to mount the tool 16 to the robot 52.

FIG. 1 also shows a typical robot jogging mouse 10 that is mounted on the robot tool 16. The mouse 10 can be grasped by the operator of the robot 52 to use the mouse 10 as a handle to jog the robot 52. Hereinafter the mouse 10 itself and its use as a jogging handle are both referred to either as a mouse or a jogging mouse. The jogging mouse 10 is attached to the robot tool 16 by using any one of the well known mechanisms such as for example and without limitation, magnetic, Velcro®, a sleeve with setscrew, and/or extruded threads. While the jogging mouse 16 shown in FIG. 1 is the Space Control ISD mouse, it should be understood that this is only illustrative of any one of a number of devices that perform the same function.

In FIG. 1, tool frame 30 specifies the position and orientation of the tool center point (TCP) 32, while mouse frame 34 defines the jogging coordinate system attached to mouse jogging. The jogging coordinate system is set by the mouse manufacturer.

As is shown in FIG. 1, in order to have the mouse 10 respond to gravity, an extra weight in the form of a ring 18 is designed and fabricated to be mountable around the jogging mouse 10. Another embodiment can use a highly sensitive mouse, which will sufficiently respond to gravity with only its own weight. In that embodiment, extra mass is not needed. In either embodiment, as is described in more detail below, the mouse directional output signal due to gravity referred to hereinafter as the “mouse output signal” is used for calibration between the mouse coordinate frame 34 and the tool coordinate frame 30. The lead through teaching device is described below with a removable extra mass, but the same methodology can from the description herein be easily applied by those of ordinary skill in this art to an embodiment wherein the mouse does not have the removable extra mass.

The ring 18 can be made of any material with enough mass to generate sufficient mouse output signals. A mouse output signal is considered sufficient when its amplitude is large enough so that the direction of gravity can be accurately detected from the mouse output signal as the orientation of the mouse changes. The added mass effectively increases the mouse output signal's magnitude for mouse designs that are not accurate and/or sensitive enough to provide a strong enough mouse output signal using their own mass alone. In one embodiment, the ring 18 was a steel shaft collar that weighed 0.8 pounds (about 0.36 kg) and had an outer diameter of 3.25″ (8.255 cm) and an inner diameter of 2.12″ (about 5.38 cm) that was machined for mounting the ring 18 onto the mouse 10.

While the extra weight is shown in FIG. 1 as a ring 18, it should be appreciated that it may have other shapes such as a toroid which can be made out of steel or rubber or other material that has sufficient mass to perform the same function as a steel ring. Furthermore, other embodiments could be created with any object of sufficient weight. This can be accomplished by attaching the object to the mouse in such a way that the object's center of gravity, when attached to the mouse, closely coincides with the center of the mouse's coordinate system. For example, another embodiment could comprise any object of sufficient weight attached to the center of mouse 10 by a string. This would perform the same function as the ring 18 described above. If a jogging stick is used in place of mouse 10, the extra weight can be in the shape of a sphere.

To achieve the calibration described below between the mouse coordinate frame 34 and the tool coordinate frame 30, the extra weight 18 should be mounted on the jogging mouse 10 such that it can exert the gravitational force as close as possible on the center of the jogging mouse 10. Even when the center of the weight 18 and the center of the mouse 10 coincide there may be a small z-axis value. That value will increase as a result of a moment around the center of mouse 10 resulting from an off-centered gravity force. Therefore, to eliminate (or minimize) such a cross-axis coupling effect, the weight 18 should be mounted on the jogging mouse 10 such that the weight 18 exerts the gravitational force through the center of the mouse 10 or as close as possible to through the center of the mouse 10.

The lead through teaching device described herein allows for easy calibration between the mouse coordinate frame and the tool coordinate frame. The calibration technique described herein uses, as is described in more detail below, two robot poses (predefined or calculated) for generating a transformation matrix to align the mouse axes and the axes of the robot's end of arm tooling. The calibration takes place in the robot controller 56 shown in FIG. 5.

Two reference poses are taught and defined to execute the calibration routine. The first robot pose is taught and defined in such a way that one of three axes (x, y, z) of the tool coordinate frame 30 points downwards (i.e. aligned with the gravitational direction). Then, the second robot pose is taught and defined in such a way that another one of three axes (x, y, z) of the tool coordinate frame 30 points downwards.

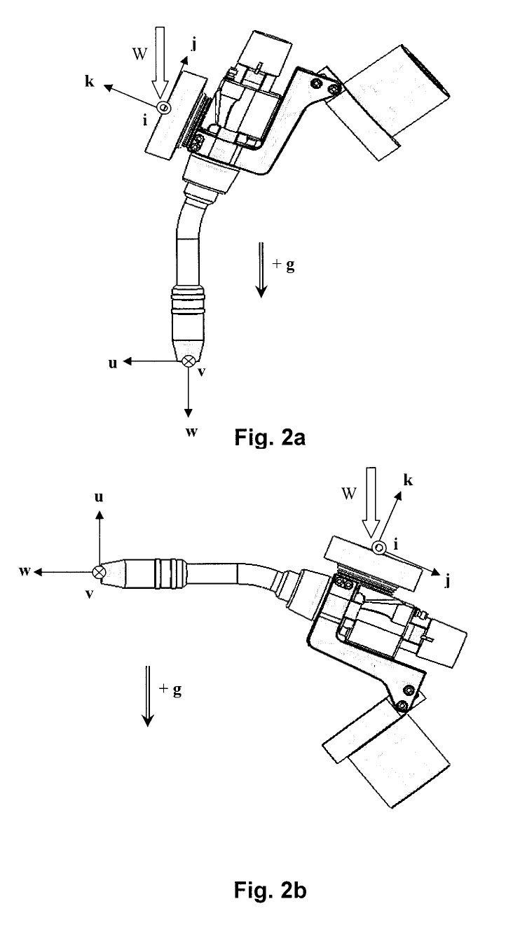

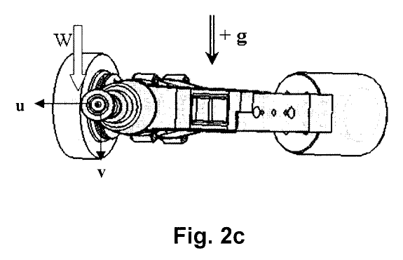

FIGS. 2a to 2c show three examples of reference poses. FIG. 2a shows the reference pose in which gravity points along the +z axis of the tool 16. FIG. 2b shows the pose in which gravity points along the −x axis of the tool 16. FIG. 2c shows the pose in which gravity points along the +y axis of the tool 16. Any two of these three example poses shown in FIGS. 2a, 2b and 2c can be selected for the calibration routine described below. It should be appreciated that the three poses shown in FIGS. 2a, 2b and 2c are only examples of reference poses since the reference poses could as another example be that gravity points along the −z axis, along the +x axis and along the −y axis.

With the calibration weight 18 mounted on the mouse's handle 10, the robot 52 moves successively to the two pre-defined positions. At each position, the mouse output signal is read and stored in a memory which can be the memory in robot controller 56 shown in FIG. 5. At each position, the mouse 10 is required to only respond to the gravitational force, without any additional external forces, such as forces due to vibration, inertia or operator intervention.

As an example which is shown in FIGS. 2b and 2c, the first and second pose is taught in such a way that the robot tool x direction and y direction point downwards, respectively.

From the first taught pose (see FIG. 2b), the mouse output signal can be generated by the gravitational force exerted on the mouse handle 10 carrying the calibration ring 18 and forms a vector: (u points downwards, so the v and w components vanish)

ru=x₁i+y₁j+z₁k

where [u, v, w] and [i, j, k] are the unit vector sets of the tool and mouse coordinate frames, 30 and 34 respectively. Both sets are shown in FIG. 2b.

A scalar value r is the total mouse reading with respect to the tool coordinate system 30, and xᵢ, yᵢ and zᵢ (i=1, 2 or 3) are the corresponding components of the mouse coordinate system 34.

From the second taught pose (see FIG. 2c in which for ease of illustration only the unit vector set of the tool coordinate frame is shown), the mouse output signal can be generated by the gravitational force exerted on the mouse handle 10 by the calibration ring 18 and forms a vector: (v points downwards, so the u and w components vanish)

rv=x₂i+y₂j+z₂k

Since any two orthogonal vectors are sufficient to specify a Cartesian coordinate frame, the third calibration step can be eliminated and the third vector can be calculated using a cross product of the two previously obtained vectors as follows:

w=u×v=x₃i+y₃j+z₃k

Since only the direction of the two vectors u and v are of concern, both sides of the equation can be normalized to a unit vector.

u=(x₁i+y₁j+z₁k)/r

v=(x₂i+y₂j+z₂k)/r

w=(x₃i+y₃j+z₃k)/r

where

r=∥x₁i+y₁j+z₁k∥=\sqrt{x₁²+y₁²+z₁²}

This leads to a matrix form as follows:

$$[ \begin{matrix}u \\ v \\ w\end{matrix} ] = \frac{1}{r} \cdot \underbrace{[ \begin{matrix}{x}_{1} & {y}_{1} & {z}_{1} \\ {x}_{2} & {y}_{2} & {z}_{2} \\ {x}_{3} & {y}_{3} & {z}_{3}\end{matrix} ]}_{T} [ \begin{matrix}i \\ j \\ k\end{matrix} ]$$

The above 3×3 matrix T is a transformation matrix which maps a vector from the mouse coordinate system to the robot tool coordinate frame.

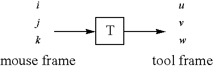

Whenever the mouse 10 is first mounted or relocated to a different position on the robot 52, a simple robot program that runs in the robot controller 56 in FIG. 5 executes the calibration described above. After the mouse 10 is mounted on a desired location on the robot 10 or robot tool 16 and the calibration weight 18 is attached on the mouse handle, the program:

1. Runs a calibration routine of:

a) Commanding robot 52 to move to pose 1 and recording the mouse output signal reading and form a pointing vector;

b) Commanding robot 52 to move to pose 2 and recording the mouse output signal reading and form a pointing vector; and

c) Evaluating a transformation matrix based on the results obtained from executing a) and b).

2. Uses this transformation matrix to transform the mouse coordinate frame 34 to the tool coordinate frame 30 during jogging.

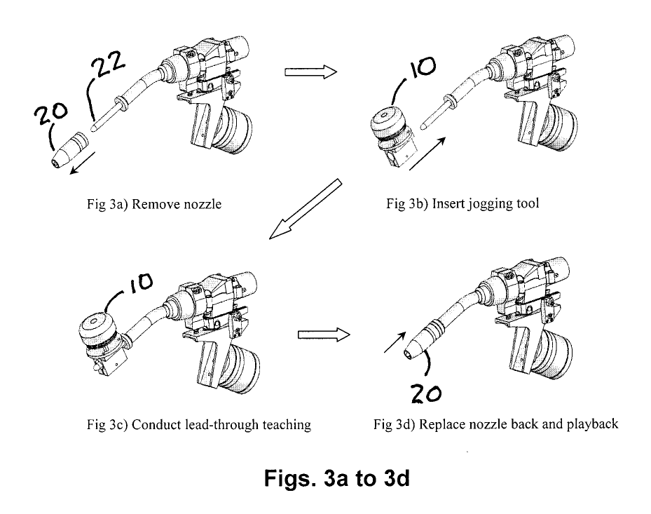

The lead through teaching device described herein allows the use of an easily removable lead-through mouse on robot tooling that has a replaceable part. One example of such tooling is, with reference to FIGS. 3a to 3d, described below for a robotic arc welding tool for which the lead-through mouse replaces the gas nozzle when it is desired to teach the robot the path the tooling must follow to perform the arc welding. Other examples of robotic tooling that have a removable part that can be replaced by a lead-through mouse when it is desired to teach the robot the path to be followed when the tool is to perform the work for which it is designed are, without limitation, milling cutters or any other tools of that type and kind that have a part that chucks into a collet; a water jet cutter nozzle; a material dispensing or mixing nozzle, for example, foam, glue, sealants, cleaning chemicals; and cleaning cannons used in high pressure washers.

For most welding torches, a replaceable gas nozzle 20 (usually made of copper) is attached to the contact tip 22 (shown in FIG. 3a described in more detail below) in order to direct inert shielding gas over the weld area. Gas nozzle 20 is located at the end of tooling 16 as one of the standard consumable parts of the tool. The jogging mouse 10 can be attached to a welding gas nozzle using brackets in order to form a single, portable jogging unit that is easily attachable and detachable from the welding gun for lead-through teaching.

The steps for attaching the jogging mouse 10 in place of the nozzle 20 attached to contact tip 22 and removing the mouse 10 and reattaching the nozzle 20 to contact tip 22 after the lead through teaching operation is completed are shown in FIGS. 3a to 3d. In FIG. 3a, the nozzle 20 is removed from the contact tip 22. In FIG. 3b, the jogging mouse 10 mounted on a bracket 24 is inserted onto the contact tip 22 in place of the removed nozzle 20. As is shown in FIG. 3c, lead through teaching of the robot 52 is conducted with the jogging mouse 10 attached to the contact tip 22. After the lead through teaching is completed, the jogging mouse 10, is as is shown in FIG. 3d, detached from contact tip 22 and the nozzle 20 is reinserted on the contact tip. The robot 52 can then be moved to follow the path or points taught by the lead through teaching.

In many cases, a robot programmer prefers to have the lead-through handle in a specific location on the robot 52 depending on his/her physical characteristics such as right-handed or left-handed, height, maneuverability or skill level.

During the entire teaching period with a lead-through handle mounted in a specific location which the programmer originally preferred, the programmer may encounter possible interference between i) the tool, ii) the workpiece and iii) lead-through handle, which is caused by varying posture or configuration of the robot wrist especially when the work area is relatively tight and limited.

For ease of use, the mouse jog direction and robot tool motion direction must be always collinear to each other. The need for a varying handle location results in the requirement of calibration between the lead-through device axis and the robot tool axis. In other words, the programmer is not able to properly jog the robot 52 in the way he/she intends, if the jogging mouse is shifted from one location to another location without a corresponding axis calibration (or transformation) procedure.

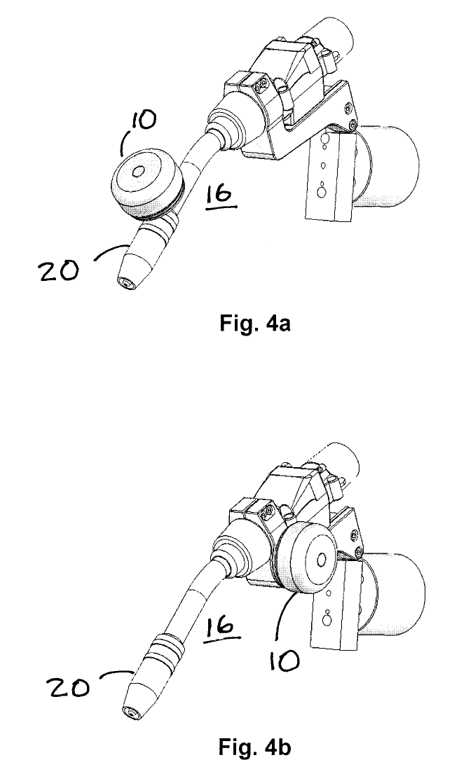

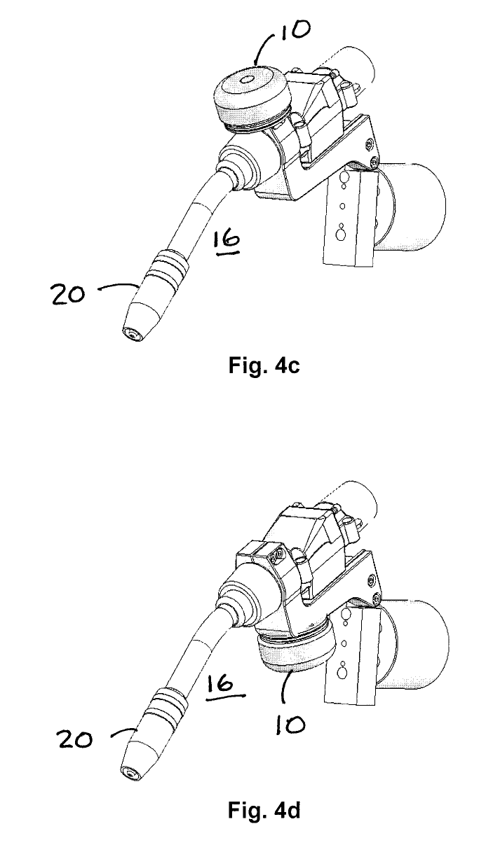

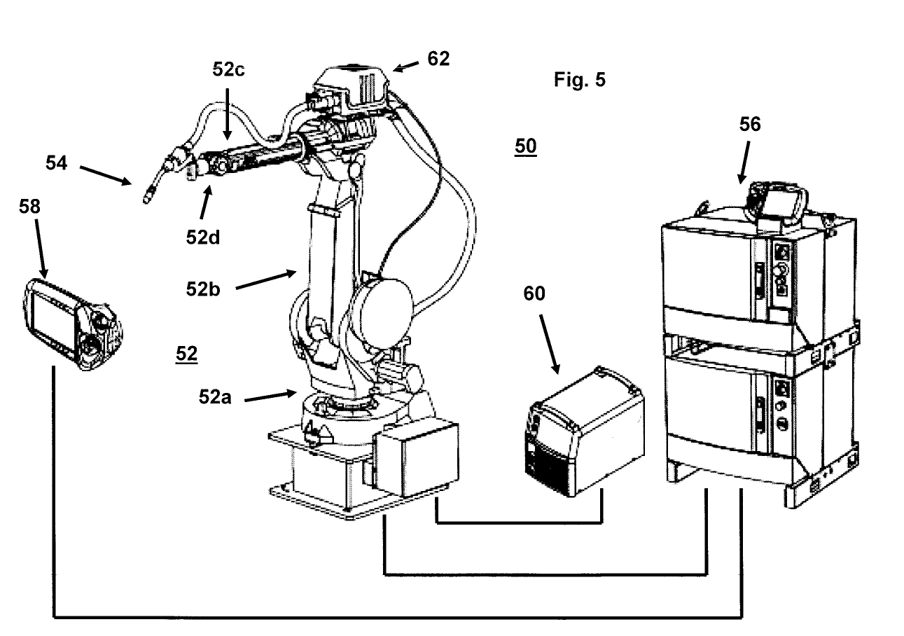

Referring now to FIGS. 4a to 4d, there are shown example locations where the jogging mouse 10 can be attached to the tooling 16 of robot 52. FIG. 4a shows the jogging mouse 10 attached around the nozzle 20. FIG. 4b shows the mouse 10 attached to the side of the tooling 16. FIG. 4c shows the mouse attached to the top of the tooling 16. FIG. 4d shows the mouse attached to the bottom of the tooling 16. It should be appreciated that FIGS. 4a to 4d are examples of how the mouse 10 can be mounted to the tool 16. It should also be appreciated that the mouse 10 can be mounted anywhere the operator wants to mount the mouse, as long as the bracket or mounting means are designed and provided to allow that mounting. As described above, examples without limitation of suitable mounting means can be in the form of a magnetic, Velcro®, sleeve with setscrew, extruded threads, etc.

Referring now to FIG. 5, there is shown a diagram of a system 50 in which the lead through teaching device described herein can be used. System 50 has an industrial robot 52 with a waist 52a, a lower arm 52b, an upper arm 52c and a wrist 52d. Mounted on the wrist is an arc welding tool 54. Connected to robot 52 are a robot controller 56, a teach pendant 58 and a welding power source 60. Mounted on robot 52 adjacent the upper arm 52c is a wire feeder 62 that is coupled to arc welding tool 54.

It is to be understood that the description of the foregoing exemplary embodiment(s) is (are) intended to be only illustrative, rather than exhaustive, of the lead through teaching device and calibration methods described herein. Those of ordinary skill will be able to make certain additions, deletions, and/or modifications to the embodiment(s) of the disclosed subject matter without departing from the spirit of the invention or its scope, as defined by the appended claims.

What is claimed is:

1. An industrial robot comprising:
a lead-through teaching device mounted in relationship to said robot to allow said robot to be moved to teach said robot a path to be used for a tool to perform work on a workpiece; and
a controller responsive to a signal from said lead-through teaching device induced by gravity and occurring at each of a predetermined number of reference poses to which said lead-through teaching device is moved for calibrating said lead-through teaching device to a predetermined coordinate frame.

2. The industrial robot of claim 1 wherein said tool is held by said robot and said workpiece is held by a device other than said robot.

3. The industrial robot of claim 1 wherein said workpiece is held by said robot and said tool is held by a device other than said robot.

4. The industrial robot of claim 2 further comprising an arm for holding said tool, said tool removably mounted on said arm.

5. The industrial robot of claim 3 further comprising an arm for holding said workpiece, said workpiece removably mounted on said arm.

6. The industrial robot of claim 2 wherein said tool has a coordinate frame and said predetermined coordinate frame is said tool coordinate frame.

7. The industrial robot of claim 3 wherein said workpiece has a coordinate frame and said predetermined coordinate frame is said workpiece coordinate frame.

8. The industrial robot of claim 1 further comprising an arm having an arc welding tool removably mounted thereon, said arc welding tool comprising a removable gas nozzle;
said lead-through teaching device adapted for mounting to said arc welding tool in place of said removable gas nozzle when it is desired to teach said robot a path for said robot to use said arc welding tool with said gas nozzle attached thereto to weld a workpiece held by a device other than said robot.

9. The industrial robot of claim 1 wherein said lead-through teaching device and said predetermined coordinate frame each have predetermined axes associated therewith and said controller is responsive to said signal occurring at each of said predetermined number of reference poses to align said lead-through teaching device predetermined axes to said predetermined axes of said predetermined coordinate frame.

10. The industrial robot of claim 9 wherein said controller performs a transformation to align said lead-through teaching device predetermined axes to said predetermined axes of said predetermined coordinate frame.

11. The industrial robot of claim 1 wherein said controller commands said robot to move to a first of said predetermined number of reference poses and record said signal from said lead-through teaching device induced by gravity at said first of said predetermined number of reference poses and then commands said robot to move to a second of said predetermined number of reference poses and record said signal from said lead-through teaching device induced by gravity at said second of said predetermined number of reference poses.

12. The industrial robot of claim 11 wherein said controller forms a first pointing vector from said signal recorded from said lead-through teaching device induced by gravity at said first of said predetermined number of reference poses and forms a second pointing vector from said signal recorded from said lead-through teaching device induced by gravity at said second of said predetermined number of reference poses.

13. The industrial robot of claim 12 wherein said controller performs a transformation that is based on said first and said second pointing vectors to calibrate said lead-through teaching device to said predetermined coordinate frame.

14. The industrial robot of claim 1 wherein said controller commands said robot to move to a first of said predetermined number of reference poses and forms a first pointing vector from said signal from said lead-through teaching device induced by gravity at said first of said predetermined number of reference poses and then commands said robot to move to a second of said predetermined number of reference poses and forms a second pointing vector from said signal from said lead-through teaching device induced by gravity at said second of said predetermined number of reference poses.

15. The industrial robot of claim 14 wherein said controller performs a transformation that is based on said first and said second pointing vectors to calibrate said lead-through teaching device to said predetermined coordinate frame.

16. The industrial robot of claim 1 further comprising a weight having a predetermined shape, said weight detachably mountable to said lead-through teaching device in a manner such that the center of gravity of said weight is substantially centered with the center of gravity of said lead-through teaching device when said robot is to be taught said path.

17. An industrial robot comprising:
a lead-through teaching device mounted in relationship to said robot to allow said robot to be moved to teach said robot a path to be used for a tool to perform work on a workpiece; and
a controller, said controller responsive to a signal from said lead-through teaching device induced by gravity and occurring at each of a first and a second reference pose to which said lead-through teaching device is moved for calibrating said lead-through teaching device to a predetermined coordinate frame.

18. The industrial robot of claim 17 further comprising an arm for holding an object, said object removably mounted on said arm, said object being said tool when said workpiece is held by a device other than said robot and said object being said workpiece when said tool is held by said device other than said robot.

19. A robotic system comprising:
an industrial robot comprising an arm having a tool mounted thereon, said tool for performing a predetermined operation on a workpiece and said tool comprising a removable component; and
a lead-through teaching device for attachment to said tool in place of said removable component when it is desired to teach said robot a path to be followed by said robot when said robot uses said tool and said removable component to perform said predetermined operation on said workpiece, and said lead-through teaching device being removable from said tool after said path is taught to said robot.
